(19) United States
(12) Patent Application Publication
(10) Pub. No.: US 2003/0120616 A1
(43) Pub. Date: Jun. 26, 2003

(54) Information mediation system

(75) Inventors: Satoshi Sueki, Tokyo (JP); Yukio Kitahara, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/322,480

(22) Filed: Dec. 19, 2002

(30) Foreign Application Priority Data
Dec. 26, 2001 (JP) 2001-393644

(51) Int. Cl. G06F 17/60

(52) U.S. Cl. 705/80; 705/1

(57) ABSTRACT

An information mediation system of a mediator includes a mediation server and a database storing information of corporate registrants. Upon receiving a request of information exchange from an applicant, the mediation server retrieves information of some of the registrants from the database, and delivers retrieved non-secret information to the applicant. If the applicant wishes to conduct information exchange with a selected registrant, the mediation server prepares the information exchange between the applicant and the registrant under a secrecy contract between the mediator and the applicant and between the mediator and the registrant.

### BACKGROUND OF THE INVENTION

(a) Field of the Invention

The present invention relates to an information mediation system and, more particularly, to an information mediation system which is capable of introducing an applicant to a registrant for exchanging information therebetween. The present invention also relates to an information mediation method used in the information mediation system.

(b) Description of the Related Art

Generally, a corporate body or corporation accumulates a large mount of information as to knowledge, experience and know-how, which is acquired by the corporate activity and stored as document information or non-document information under ministration. By efficiently using such information on producing and selling articles of the corporation, the corporation can stand on predominance in the corporate activity.

When a corporation (or corporate buyer) plans to introduce therein a new manufacturing machine or a new administration program (referred to as simply equipment hereinafter), the buyer does not have sufficient information as to operation and maintenance of the machine or program to be introduced. Thus, the buyer generally asks the corporate vendor, which sells the machine or program, to provide such information to the buyer. The vendor usually provides such information including knowledge or know-how of operating the equipment to the buyer for supporting the operation by the buyer However, it often happens that the information provided by the vendor includes only so-called sales talk such as the merits of the introduction without including the demerits of the introduction or difficulties in the operation of the equipment. In other words, it is difficult for the corporate buyer to receive the important information desired by the buyer.

On the other hand, a third party which introduced in the past equipment similar to the equipment that the buyer is to introduce possesses such information or other information to use the equipment thereby. Accordingly, the buyer sometimes desires the third party for cooperation therewith or provision of the information therefrom, after the third party is introduced to the buyer by the corporate vendor or after the buyer itself manages to find the third party.

It is not assured that the buyer succeeds in asking the third party to cooperate therewith, and in addition, such an agreement to the cooperation sometimes needs a skilled mediator.

Moreover, such information for operating the equipment often includes corporate secrets, which necessitate a secrecy contract between the buyer and the third party so that the corporate secrets are not disclosed by the buyer to other parties. However, such a secrecy contract is generally concluded based on the technical and legal knowledge for the contract and may be a considerably heavy burden on both the sides having few experiences on the contract.

Furthermore, with the third party which introduced the machine or product and is asked to provide the information thereof, it is generally considered that there are few merits on such a contract of providing the information. Thus, the third party is generally not willing to provide the information, unless the buyer has some information that the third party wishes, and unless there is a balance between both the sides as to the corporate scale or there are common problems therebetween. It is beneficial if a mediator provides a field for exchanging such information therein while combining the interests of both the corporations. However, there has been no such a mediator acting between the corporations.

### SUMMARY OF THE INVENTION

In view of the above, it is an object of the present invention to provide a information mediation system which is capable of mediating exchange of information between an applicant and a registrant while assuring secrecy of the exchanged information away from third parties.

It is another object of the present invention to provide an information mediation method for mediating exchange of information between the applicant and the registrant.

The present invention provides an information mediation system managed by a mediator, including a mediation server connected to a plurality of user terminals through a network, and a database for storing information of a plurality of registrants, the mediation server having the functions of: retrieving information of at least one of the registrants from the database upon receiving a request of information exchange from an applicant; transmitting at least a part of the retrieved information of the at least one of the registrants to the applicant; upon receiving from the applicant information of a selected registrant selected among the at least one of the registrants, transmitting an inquiry to the selected registrant as to whether or not the selected registrant approves the request of the information exchange; and upon receiving approval of the request from the selected registrant, transmitting information of the approval to the applicant.

The present invention also provides an information mediation method including the steps of: storing information of a plurality of registrants in a database; retrieving information of at least one of the registrants from the database upon receiving a request of information exchange from an applicant; transmitting at least a part of the retrieved information of the at least one of the registrants to the applicant; upon receiving from the applicant information of a selected registrant selected among the at least one of the registrants, transmitting an inquiry to the selected registrant as to whether or not the selected registrant approves the request of information exchange; and upon receiving approval of the request from the selected registrant, transmitting information of the approval to the applicant.

In accordance with the information mediation system and the method of the present invention, all of the applicant, registrant and mediator can receive some advantages from the mediation conducted by the information mediation system. The exchanged information is not subjected to a risk of leakage of the secrets by concluding a secrecy contract.

The above and other objects, features and advantages of the present invention will be more apparent from the following description, referring to the accompanying drawings.

### BRIEF DESCRIPTION OF THE DRAWINGS

FIG. 1 is a block diagram of an information mediation system according to an embodiment of the present invention.

FIG. 2 is a flowchart of the registration procedure used in the information mediation system of FIG. 1.

FIG. 3 is a flowchart of the mediation procedure used in the information mediation system of FIG. 1.

FIG. 4 shows a form of application information displayed on a display unit of an applicant for the information mediation system of FIG. 1.

### PREFERRED EMBODIMENTS OF THE INVENTION

Now, the present invention is more specifically described with reference to accompanying drawings.

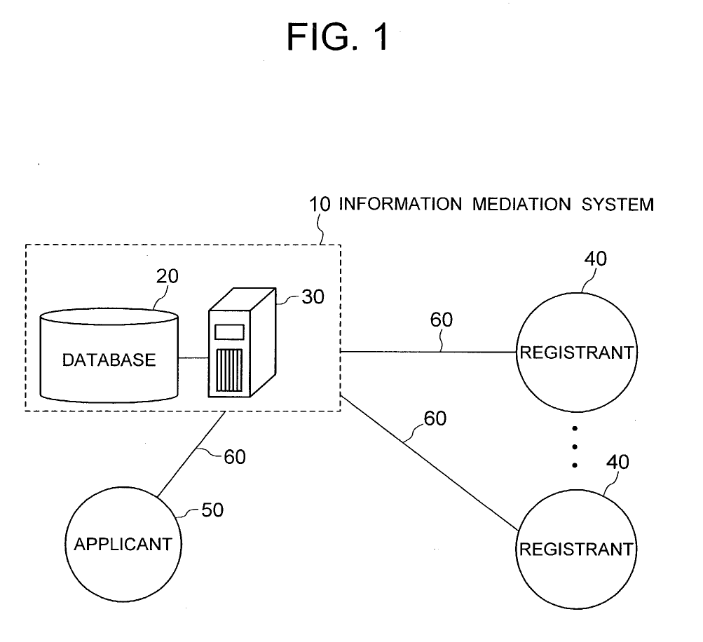

Referring to FIG. 1, an information mediation system, generally designated by numeral 10, according to an embodiment of the present invention is managed by a corporate mediator, and includes a mediation server 30 as a main computer of the system and a registrant database 20 for storing information of corporate registrants 40. The information mediation system 10 is connected to terminals of the corporate registrants 40 and terminals of corporate applicants 50 via a network or networks 60. The applicant 50 may be a buyer which wishes to receive information from the registrants via the mediation by the information mediation system 10.

The registrant database 20 stores therein information of the registrants 40 which may include secret information and non-secret information of the registrants 40. The mediation server 30 allows a plurality of users including an applicant 50 and registrants 40 to access thereto and mainly acts as a user interface member therebetween. The mediation server 30 has functions of registering information of the registrants 40, retrieving information of the registrants 40 based on the application information received from the applicant 50, concluding secrecy contracts between the mediator and the applicant 50 and between the mediator and a registrant 40, adjusting in advance the theme of the information exchange, and serving as a field for the applicant 50 and the registrant 40 to exchange therein the corporate information therebetween via the network 60.

A user or registrant-to-be applies to the mediation server 30 via the network 60 for registration of the corporate information and becomes a registrant 40 after approval for registration and registration of the corporate information. The applicant 50 may be any corporation which wishes exchange of information between the same and one or more of the registrants 40. A registrant 40 wishing exchange of information between the same and another registrant 40 may also apply to the information mediation system 10 to become an applicant 50.

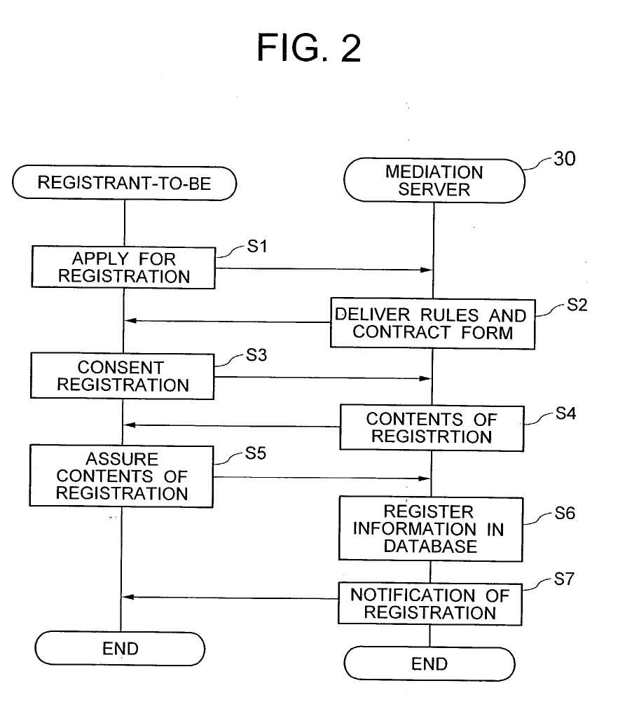

Referring to FIG. 2, there is shown a procedure for registration of the information of a registrant-to-be in the information mediation system of FIG. 1. The registrant-to-be wishing registration in the information mediation system 10 delivers the own information to the mediation server 30 and applies for registration of the own information in the information mediation system 10 (step S1). The information to be registered includes secret information and non-secret information that the registrant-to-be has. The registrant-to-be specifies among the own information the range of the non-secret information, which may be open to a third party or an applicant for information exchange after registration of the own information.

The mediator as well as the information mediation system 10 examines the information delivered from the registrant-to-be and judges whether or not the information mediation system should register the information of the registrant-to-be. If the mediator having the information mediation system 10 judges that the registration should be approved, then the mediation server 30 delivers information of rules in the information mediation system 10 and a form of the contract between the registrant 40 and the information mediation system 10 (step S2). The contents of the contract explicitly include a secrecy obligation which prohibits the registrant 40 from indicating to a third party the information that the registrant 40 received via the mediation by the information mediation system 10, and other obligations that the user of the information mediation system 10 ought to take.

The registrant-to-be, if agrees to the contents of the contract, delivers an agreement of the contract to the mediation server 30 (step S3). The mediation server 30 then delivers the information of the registrant-to-be which was received therefrom and requests the consent of registration of the contents of the information by the registrant-to-be, while distinguishing the range of the non-secret information from the secret information (step S4). The registrant-to-be then delivers the consent of registration after it examines accuracy of the contents of the information to be registered (step S5).

The mediation server 30, after receiving the consent from the registrant-to-be, stores the information in the registration database 20 (step S6), and notifies the new registrant 40 of the registration of the information in the database 20 (step S7). If the mediator having the information mediation system 10 judges that registration for the registrant-to-be should not be allowed for some reason, the mediation server 30 delivers information of such judge via an e-mail to the registrant-to-be, and stops the registration itself.

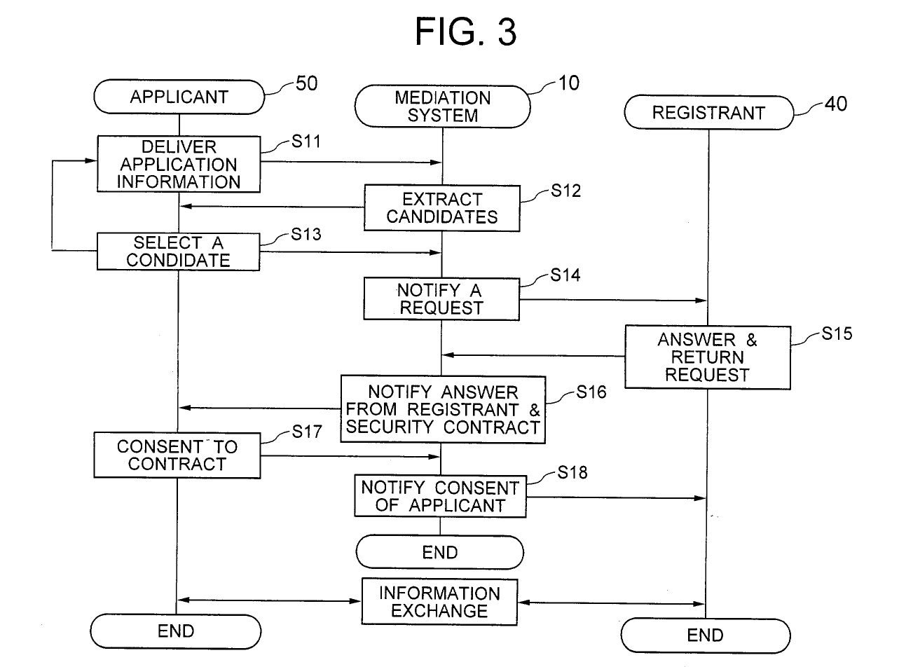

Referring to FIG. 3, there is shown a mediation procedure in the information mediation system of FIG. 1. An applicant 50 wishing mediation of information exchange by the information mediation system 10 delivers an application information including the own information and conditions of the desired information exchange to the mediation server 30 (step S11).

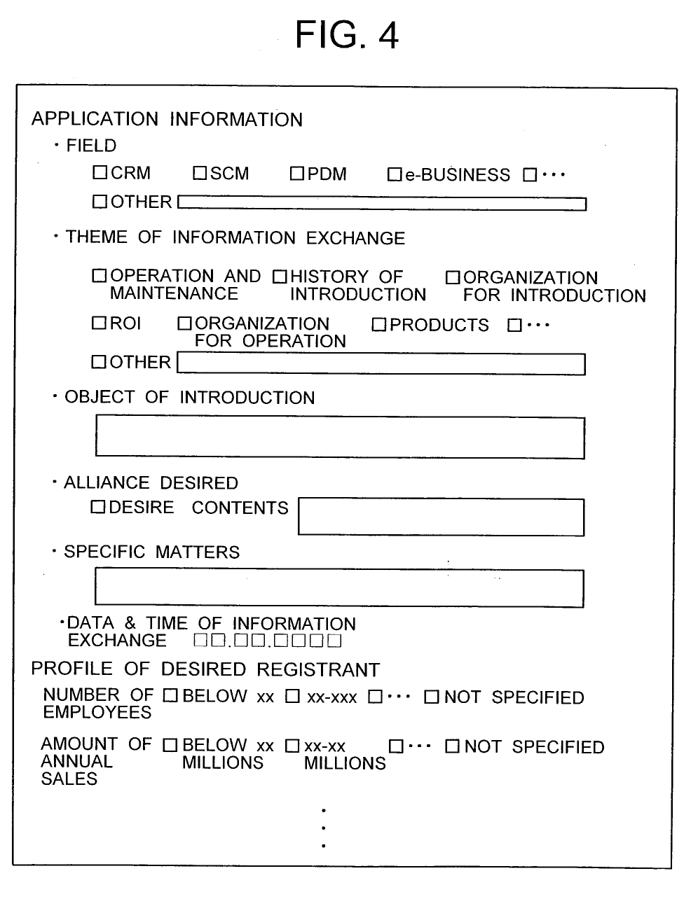

Referring to FIG. 4, the application information to be input on the terminal unit of the applicant 50 includes the field or genre of the information exchange desired by the applicant, such as CRM, SCM, e-business etc, the concrete theme for the information exchange, object of the information exchange, presence or absence of desire for alliance and the contents of the desired alliance, if any, specific information and the date or time for the information exchange. The application information may include, in addition thereto, mediation conditions including the scale of the corporate registrant 40, such as the number of employees or amount of annual sales. The application information is delivered to the mediation server 30 and stored therein.

The mediation server 30 then retrieves the registrants 40 stored in the database 20 based on the application information to extract one or more candidates for the information exchange (step S12). The information of the names or IDs of the retrieved candidates is delivered to the applicant 50. The applicant selects one or more of the candidate registrants which the applicant considers is best suited for the information exchange and delivers the name or ID of the selected candidate to the mediation server 30 (step S13). If no suitable candidate is not found in the retrieved candidates, the process returns to step S11, where the conditions in the application information are modified, followed by iterating steps S12 and S13.

The mediation server 30, after receiving the name or ID of the selected candidate or candidates from the applicant in step S12, notifies the selected candidate or candidates of the information including occurrence of the application for information exchange and the theme etc. of the information exchange (step S14). The selected candidate or registrant 40 thus notified examines the contents of the information exchange and determines whether or not the selected registrant 40 should accept the information exchange with the applicant 50 based on the application information.

The selected registrant 40 then delivers an answer to the mediation server 30 as to whether or not the selected registrant 40 approves the request of the information exchange. If the answer is affirmative, the selected registrant 40 may add a return request of additional information exchange that the selected registrant 40 wishes to conduct, the information of the return request including at least the theme of the additional information exchange. The mediation server 30 notifies the applicant 50 of the answer from the selected registrant 40, and delivers a form and the contents of the contract including secrecy obligation to the applicant 50 (step S16), if the answer is affirmative.

The contract of the information exchange is concluded between the applicant 50 and the mediator possessing the information mediating system 10. The contract includes a secrecy obligation contract whereby the applicant is prohibited from disclosing the information obtained in the information exchange to a third party after the information is exchanged between the applicant 50 and the selected registrant 40. More specifically, the selected registrant 40 is assured by the mediator as to the secrecy of the information by the applicant 50. The applicant 50 examines the contract provided by the mediation server 30, delivers consent to the contents of the contract as well as an answer to the return request provided by the selected registrant 40.

After the mediation server 30 notifies the selected registrant 40 of the answer from the applicant 50 (step S18), preparation for the information exchange is completed. The overall mediation procedure via the information mediating system 10 is finished in this step. At this stage, the mediator may be paid by the applicant 50 for introduction of the applicant 50 to the registrant 40. Thereafter, the applicant 50 and the selected registrant 40 may exchange information therebetween at their discretion as by conducting a personal talk, inspection of the equipment in the factory, or exchange of desired data.

The information mediation system of the present embodiment provides a field for the information exchange between the applicant 50 and the registrant 40 with assured secrecy on the theme previously agreed therebetween. Thus, the applicant 50 can find the registrant 40 having desired information with ease via the mediation server 30. The registrant 40 may select the applicant which the registrant considers has merits of the information exchange for the registrant 40 among the applicants that the information mediation system 10 introduced. An efficient information exchange can be conducted to both the applicant 50 and the registrant 40 due to the pre-adjustments of the theme between the applicant 50 and the registrant 40 via the information mediation system 10.

A practical example of mediating the information exchange by using the information mediation system 10 will be described hereinafter, wherein it is assumed that an applicant 50 considering introduction of equipment therein wishes information exchange with a third party that has introduced similar equipment. In this case, the corporate vendor is suited as the mediator in the present invention. The applicant 50 asks the corporate vendor to mediate the information exchange as to the know-how of operation of the equipment.

The mediation server 30 retrieves some of the registrants 40 from the database 20, the some of the registrants 40 having information of the equipment and also having a corporate scale etc. matching with the corporate scale etc. of the applicant 50 specified in the application information by the applicant 50. The mediation server 30 then notifies the applicant 50 of the information of the retrieved registrants. The applicant 50 selects one of the notified registrants 40 which the applicant 50 considers best matches therewith after studying the conditions such as locations, statuses and reputations of the notified registrants 40. The applicant 50 then notifies the name or ID of the selected registrant 40 to the mediating server 30, which in turn notifies the selected registrant 40 of the occurrence of a request of the information exchange.

The registrant 40 thus notified judges whether or not the registrant 40 should accept the information exchange requested from the applicant 50. If the registrant considers that the applicant is a possible competitor or there is little merit expected in the information exchange on the registrant side, the registrant 40 delivers a negative reply. On the other hand, if the registrant 40 considers there is some merit on the registrant side, the registrant 40 delivers to the mediation server 30 an affirmative reply together with the return request that the registrant 40 has. This case may arise, for example, if the registrant 40 considers replacement of the equipment which is now under operation, and wishes to obtain information of the applicant 50 which now considers the introduction thereof.

After the mediation server 30 receives an affirmative reply from the registrant 40, the mediation server 30 delivers a proposal of conclusion of secrecy contract to the applicant 50 together with the information of the affirmative reply and the return request of the registrant 40 thus received. If the applicant 50 agrees to the conclusion of the secrecy contract and the return request of the registrant 40, the mediation server 30 notifies information of the agreement by the applicant 40 to the registrant 40. After the notification, both the applicant 50 and the registrant 40 can make arrangements without using the mediation server 30, thereby conducting the information exchange as by visiting each other.

In the exemplified embodiment, the applicant 50 receives, before introduction of the equipment, information of the experiences and know-how of the registrant 40 which introduced similar equipment. Thus, the applicant 50 advantageously obtains information of the matters to be kept in mind before and after introduction of the equipment. On the other hand, the registrant 40 may obtain perceptions of the other corporation and use such information in the replacement etc. of the equipment, substantially without the risk of leakage of own secrets.

The corporate vendor acting as the mediator can provide a high-quality customer service to both the customer and the customer-to-be. In addition, the requests from the applicant 50 for the equipment which may occur as the results of the information exchange may provide valuable points for improvement of the equipment. In short, all the parties concerned may obtain some significant advantages from the mediation.

The contracts of the secrecy are concluded between the applicant 50 and the mediator, and between the registrant 40 and the mediator. That is, both the applicant 50 and the registrant 40 are assured of the secrecy by the mediator. If the mediator is a corporation of high reputation and prestige, the assurance of the secrecy by the mediator possesses a higher reliability.

The applicant 50 and the registrant 40 need not be corporations operating in the same field of business, and the information exchange between corporations of different fields both having different weak points and strong points may result in compensation or reinforcement of the corporate abilities. The information exchange may yield a joint venture operating in a new field between both the fields of the corporations.

In the above embodiment, the mediation server 30 retrieves the registrants 40 from the database 20. In an alternative, the applicant 50 may directly retrieve the registrants 40 based on the open information of the registrants 40 which may be open to the public via the internet. In such a case, if a registrant 40 is not retrieved from the database 20 based on the retrieval conditions specified by the applicant 50, the retrieval can be iterated for a plurality of times based on new retrieval conditions modified by the applicant 40. This may reduces the time length for the retrieval.

After preparation of the information exchange, the applicant 50 and the registrant 40 may use, in the information exchange, the mediation server 30 via the network 60 or without using the mediation server 30. If the data wished by the applicant 40 is stored in the database 20 as secret information, the mediation server 30 may participate in the information exchange by retrieving and transmitting the secret information to the applicant.

The mediator may be a corporate vendor or a non-profit is body, which may activate the corporate operations in the business society.

Since the above embodiments are described only for examples, the present invention is not limited to the above embodiments and various modifications or alterations can be easily made therefrom by those skilled in the art without departing from the scope of the present invention.

What is claimed is:

1. An information mediation system managed by a mediator, comprising a mediation server connected to a plurality of user terminals through a network, and a database for storing information of a plurality of registrants, said mediation server having the functions of:
retrieving information of at least one of said registrants from said database upon receiving a request of information exchange from an applicant;
transmitting at least a part of said retrieved information of said at least one of said registrants to said applicant;
upon receiving from said applicant information of a selected registrant selected among said at least one of said registrants, transmitting an inquiry to said selected registrant as to whether or not said selected registrant approves said request of information exchange; and
upon receiving approval of said request from said selected registrant, transmitting information of said approval to said applicant.

2. The information mediation system according to claim 1, wherein said information stored in said database includes non-secret information and secret information, and said at least a part of said retrieved information includes non-secret information.

3. The information mediation system according to claim 1, wherein said applicant undertakes a secrecy obligation in a contract concluded between said applicant and said mediator.

4. The information mediation system according to claim 1, wherein, upon receiving a return request in return of approval of said information exchange from said selected registrant, said mediation server delivers said return request to said applicant before or concurrently with delivering said approval therefrom.

5. The information mediation system according to claim 4, wherein said selected registrant undertakes a secrecy obligation in a contract concluded between said selected registrant and said mediator.

6. The information mediation system according to claim 1, wherein said applicant is allowed to retrieve at least one of said registrants from said database in place of or in addition to said retrieval by said mediation server.

7. An information mediation method used by a mediator, comprising the steps of:
storing information of a plurality of registrants in a database;
retrieving information of at least one of said registrants from said database upon receiving a request of information exchange from an applicant;
transmitting at least a part of said retrieved information of said at least one of said registrants to said applicant;
upon receiving from said applicant information of a selected registrant selected among said at least one of said registrants, transmitting an inquiry to said selected registrant as to whether or not said selected registrant approves said request of information exchange; and
upon receiving approval of said request from said selected registrant, transmitting information of said approval to said applicant.

8. The information mediation method according to claim 7, wherein said information stored in said database includes non-secret information and secret information, and said at least a part of said retrieved information includes non-secret information.

9. The information mediation method according to claim 7, wherein said applicant undertakes a secrecy obligation in a contract concluded between said applicant and said mediator.

10. The information mediation method according to claim 7, further comprising, upon receiving a return request in return of approval of said information exchange from said selected registrant, the step of delivering said return request to said applicant before or concurrently with delivering said approval therefrom.

11. The information mediation method according to claim 10, wherein said selected registrant undertakes a secrecy obligation in a contract concluded between said selected registrant and said mediator.

12. The information mediation method according to claim 8, wherein said retrieving step allows said applicant to retrieve at least one of said registrants from said database.
